(19) United States
(12) Patent Application Publication
(10) Pub. No.: US 2010/0273460 A1
(43) Pub. Date: Oct. 28, 2010

(54) INTEGRATED ALERT SYSTEM

(76) Inventor: Angus MacDonald DORBIE, San Diego, CA (US)

Correspondence Address: QUALCOMM INCORPORATED, 5775 MOREHOUSE DR., SAN DIEGO, CA, 92121, US

(21) Appl. No.: 12/430,665

(22) Filed: Apr. 27, 2009

(51) Int. Cl. H04M 3/42; H04W 4/02

(52) U.S. Cl. 455/414.1; 455/456.3

(57) ABSTRACT

The specification and drawing figures describe a method of automatically providing an integrated alert to the user of a mobile wireless communications instrument on the substantial imminent or actual occurrence of an event and geographic location. A programmable algorithm in the form of an executable program is installed in the mobile wireless communications instrument, which is connectable to a location determination system. Optionally a graphical mapping subsystem is included.

### FIELD OF TECHNOLOGY

The apparatus, methods and systems disclosed, illustrated and claimed in this document pertain generally to an alert system. More particularly, the alert system of this document integrates both scheduled events and information pertaining to geographic location, displays the scheduled event and geographic location on a mobile wireless communication instrument, and prompts the user of the mobile wireless communications instrument about either the happening or occurrence of one scheduled event, and the happening or occurrence of at least one geographic location, and/or the integration of the occurrence of both a scheduled event and a geographic location by providing an alert notification to the user of the mobile wireless communications instrument.

### BACKGROUND

Software and associated algorithms and protocols installed in mobile communications instruments, such as cellular telephones and personal digital assistants (“PDA's”), allow a user of a mobile wireless communications instrument to schedule events by entering data concerning the event into software, hardware, and/or firmware of the mobile wireless communications instrument. Other systems have been developed to alert either a user of a mobile wireless communications instrument, or alternatively, to alert a network management center that in turn may alert one or more users of a mobile wireless communications instrument of the happening or occurrence of the event. The data and information is communicable across a mobile wireless communications system.

At least one limitation of such prior approaches is the fact that, unlike the integrated alert system described in this document, the data and information in connection with scheduled events and geographic location are not integrated to operate substantially in unison. For example, current systems may provide a user with what generally are referred to as to-do lists containing scheduled events displayed on one or more event windows. Target completion dates may be associated with the to-do lists. Other events may be associated with calendar dates and times. What is absent from the current system is what is disclosed in this document, namely an integrated alert system enabling a user of a mobile wireless communications instrument to specify one or more desired alerts based on a combination of the happening or occurrence of a scheduled event in unison with the happening or occurrence of the coincidence of the scheduled event and one or more geographic locations. The location determination information may trigger an alert based either on imminent proximity to a predetermined geographic location, and/or if appropriate or desired by the user, also by association with a scheduled event.

A need exists in the industry for a new and useful integrated alert system that is capable of providing a single alert on the occurrence and confluence of both a scheduled event and a geographic location.

### SUMMARY

The problem solved by the integrated alert system of this document is to provide a user with a single alert based on the combined data and information associated with geographic locations and scheduled events occurring substantially in unison.

The apparatus, methods and systems disclosed, illustrated and claimed in this document address the above-stated needs by providing an integrated alert notification system. The integrated alert system includes at least one mobile wireless communications instrument. The mobile wireless communications instrument includes and is operatively connected to a programmable algorithm stored in the mobile wireless communications instrument. The programmable algorithm preferably is stored in a data processing system installed on the mobile wireless communications instrument. In addition, the mobile wireless communications instrument is operatively connectable to a location determination system for obtaining geographic location data. In one aspect of the integrated alert system, a graphical mapping subsystem also may be operatively connected to the programmable algorithm and to the location determination system for providing visual variety in the form of the geographic location data displayed on the mobile wireless communications instrument. A user may enter one or more scheduled events into the programmable algorithm, and also may enter one or more geographic locations into the programmable algorithm. On the occurrence of a scheduled event, in combination with the occurrence of imminent proximity to a geographic location, and/or actual entry into a geographic location, the programmable algorithm sends an alert notification in a variety of different visual presentations to be sensed, heard, or seen by the user of a mobile wireless communications instrument.

It will become apparent to one skilled in the art that the claimed subject matter as a whole, including the structure of the apparatus, and the cooperation of the elements of the apparatus, combine to result in a number of unexpected advantages and utilities. The structure, and co-operation of structure, of the integrated alert system will become apparent to those skilled in the art when read in conjunction with the following description, drawing figures, and appended claims.

The foregoing has outlined broadly the more important features of the integrated alert system to better understand the detailed description that follows, and to better understand the contributions to the art. The integrated alert system is not limited in application to the details of construction, and to the arrangements of the components, provided in the following description or drawing figures, but is capable of other embodiments, and of being practiced and carried out in various ways. The phraseology and terminology employed in this disclosure are for purpose of description, and therefore should not be regarded as limiting. As those skilled in the art will appreciate, the conception on which this disclosure is based readily may be used as a basis for designing other structures, methods, and systems. The claims, therefore, include equivalent constructions. Further, the abstract associated with this disclosure is intended neither to define the integrated alert system, which is measured by the claims, nor intended to limit the scope of the claims. The novel features of the integrated alert system are best understood from the accompanying drawing, considered in connection with the accompanying description of the drawing, in which similar reference characters refer to similar parts, and in which:

### BRIEF DESCRIPTION OF THE DRAWING

FIG. 1 is a diagrammatic representation of the integrated alert system operating within the environment of a mobile wireless communications system;

FIG. 2 is a diagrammatic representation of a data processing system associated with the integrated alert system;

FIG. 3 is a representation of a visual screen or monitor presentation for a prior art method of recording scheduled events;

FIG. 4 is an alternative representation of a prior art presentation of scheduled events;

FIG. 5 is an alternative representation of another prior art method of presenting scheduled events;

FIG. 6 is a pictorial illustration of one of several alternative ways to identify a geographic location using the integrated alert system; and

FIG. 7 is a flowchart showing at least one aspect of the operation of the integrated alert system.

To the extent that the numerical designations in the drawing figures include lower case letters such as “a,b” such designations include multiple references, and the letter “n” in lower case such as “a-n” is intended to express a number of repetitions of the element designated by that numerical reference and subscripts.

### DETAILED DESCRIPTION

### Definitions

The term “mobile wireless communications instrument” and “portable wireless communications instrument” as used in this document means at least a wireless communication instrument used in a wireless communications system that, in general, includes an array of operatively connected communication devices adapted to receive and transmit at least electromagnetic signals across the system without cables using at least infrared light and radio signals, and also includes a telecommunications system in which electromagnetic waves, rather than some form of wire, carry the signal over all or part of the communication path. The mobile wireless communications instrument may also receive and transmit signals from satellites, including satellites that are part of the Global Positioning System (“GPS”), Galileo, GLONASS, NAVSTAR, GNSS, a system that uses satellites from a combination of these systems, or any satellite positioning and/or location determination system (collectively referred to generally in this document as a Satellite Positioning System (“SPS”)). As used in this document, an SPS also includes pseudolite (pseudo-satellite) systems. In addition, the mobile wireless communications instrument may also receive and transmit signals from terrestrial resources including, but not limited to, ground based triangulation positional tracking services and devices such as GSM Localization. The term “GSM Localization” refers to use of multilateration to determine the location of a GSM-enabled mobile wireless communications instrument such as, for example, a mobile wireless telephone, usually with the intent of identifying the location of a user. The term “multilateration” includes hyperbolic positioning, the process of positional tracking by accurate computation of time difference of arrival of a signal emitted from the object to be located to a plurality of receivers and/or transceivers.

The term “instrument” in combination with the words “mobile wireless communications” and “portable wireless communications instrument” means and includes at least a cellular telephone, cell phone, pager, satellite telephone, two-way pager, personal digital assistant (“PDA”) having wireless capabilities, portable computer having wireless capabilities, home entertainment system control boxes, wireless local area network apparatus, and any other type of wireless device having transmission capabilities that may also be one or more versions of a personal communications services device (“PCS”) including time division multiple access (“TCMA”), a code division multiple access (“CDMA”), a global system for mobile (“GSM”), non-voice communications apparatus, and text transmission apparatus, among others.

The term “alert” or “alerting” as used in this document means an aural, visual, vibratory, or any other way of notifying a user of a mobile wireless communications instrument about an imminent or actual event or other occurrence of interest to a user of a mobile wireless communications instrument. At least one contribution to the art by the integrated alert system disclosed in this document is integrating speed and velocity factors as spatial criteria. In one non-exclusive example, vehicle speed limits along transit routes in urban areas are subject to frequent changes as the transit route traverses commercial, semi-commercial, residential and construction zones. The integrated alert system includes data and information about such varying speed limits. Accordingly, alerts may be one or more pre-recorded audio warnings to a user of the integrated alert system that the speed limits along the transit route is being exceeded or is about to change to a different speed limit.

The term “event” means a planned or optional action or omission, a reminder, a geographical location, or any item of information a user of a mobile wireless communications instrument desires to recall or respond to.

The term “scheduled event” is an event that a user has entered into the integrated alert system described, illustrated and claimed in this document.

The term “coordinates” means any set of numbers or other data used to specify the geographic location of a point on a line, surface, or in space, such as the location of the beginning and end of one or more identified transit segments of a transportation network.

The term “location determination system” means an apparatus, method and/or system that is capable of providing at least geographical locations to at least to a mobile wireless communications instrument. Position determination techniques described in this document may be used for various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be used for any combination of WWAN, WLAN and/or WPAN.

The term “graphical mapping subsystem” means a method for identifying a geographical location operatively connectable to a mobile wireless communications instrument.

The term “geographic location” means not only a location identified by specific geographic coordinates, but also a geographic area, a postal zip code or similar postal delivery area, an identifiable boundary, a user-created boundary or area, a geographic distance between a mobile wireless communications instrument and a desired geographic location, and any other location identification.

The term “shape” means an illustration of a box, polygon, line, circle or any other figure or character used by the alert system of this document to identify and/or define a geographic location.

The term “user” means a subscriber and/or user of a mobile wireless communications instrument.

The term “network management center” means at least one or more base stations that may be operated to monitor, receive, store, process and transmit data and information across a mobile wireless communications system.

The term “exemplary” means serving as an example, instance, or illustration; any aspect described in this document as “exemplary” is not intended to mean preferred or advantageous over other aspects of the invention.

### Description

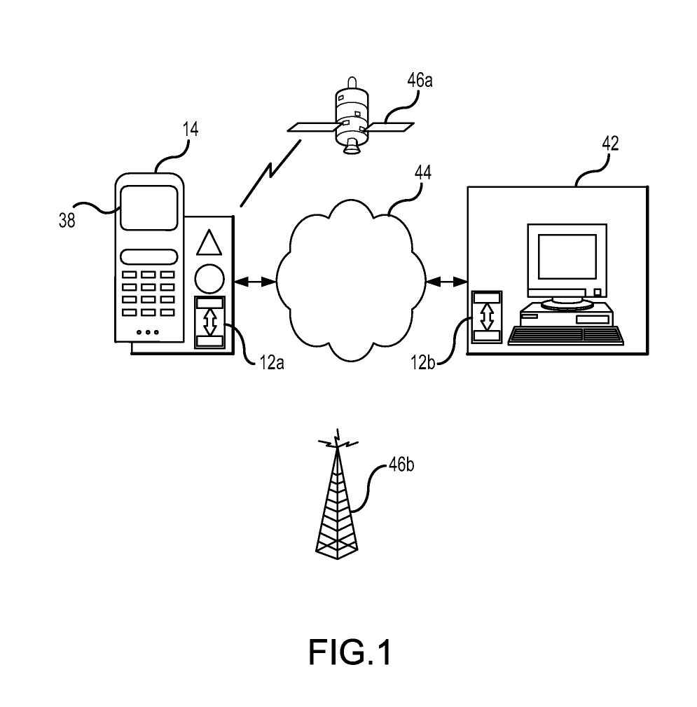

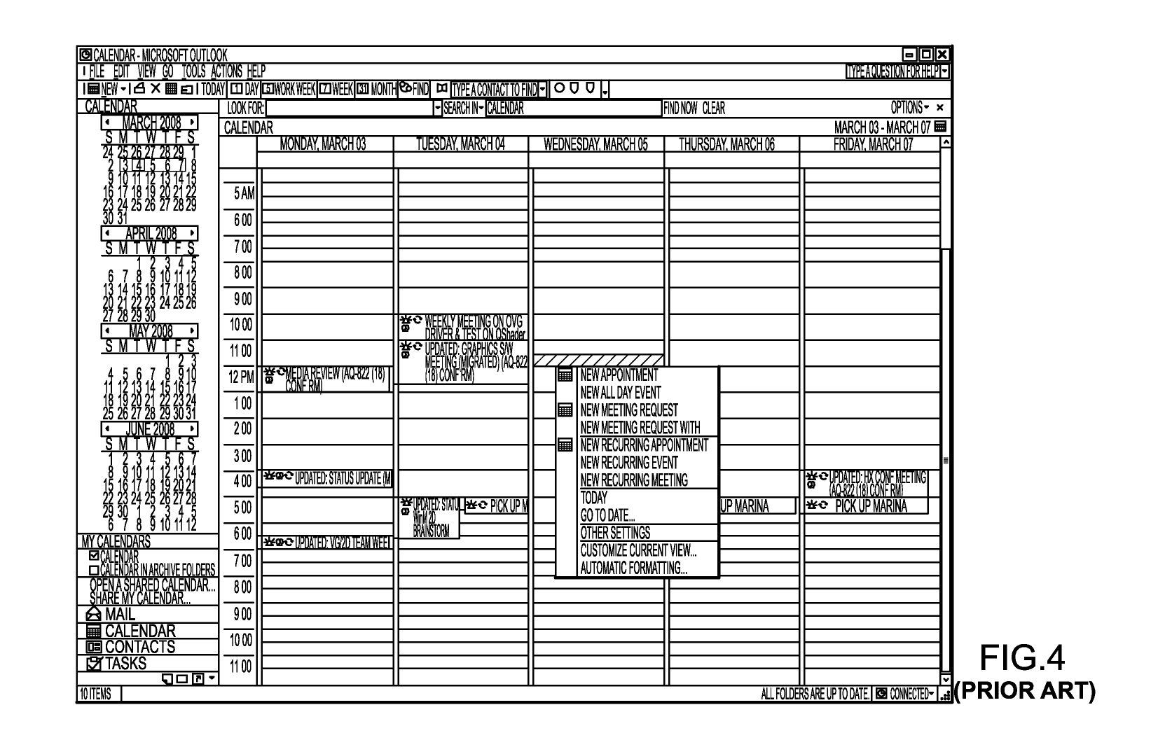

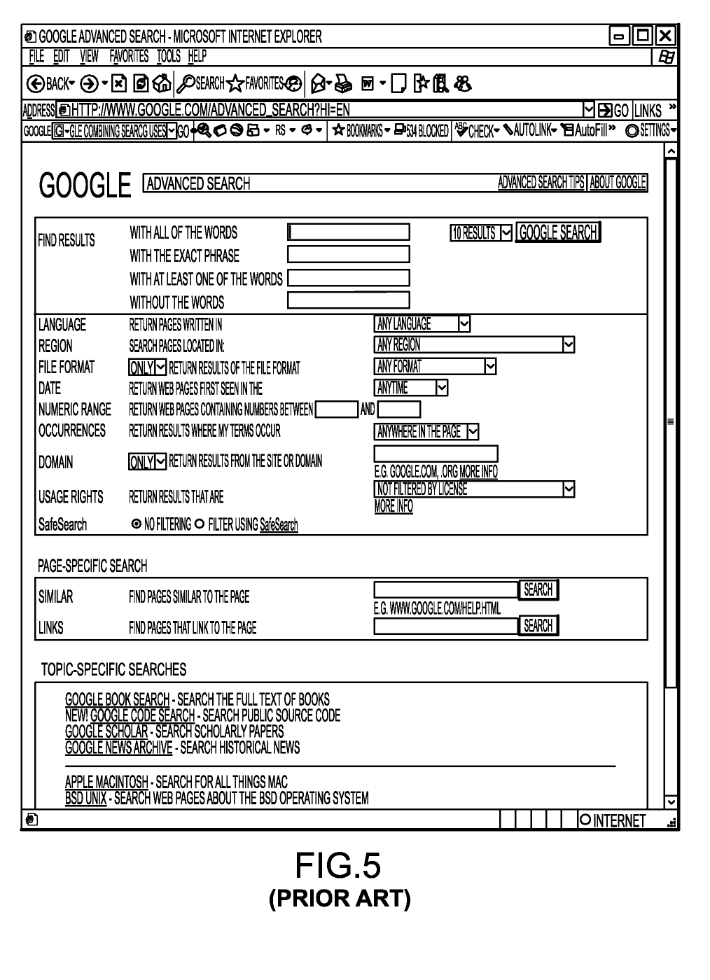

As illustrated by cross-reference between FIGS. 1-7, an integrated alert system is illustrated that in its broadest context includes the following: The integrated alert system includes at least one mobile wireless communications instrument. The mobile wireless communications instrument is operatively connected to a programmable algorithm that is stored in the mobile wireless communications instrument. The programmable algorithm is designed to be responsive to at least one event, scheduled event, coordinates provided by a location determination system, geographic location, shape or other data and information that individually is referred to as a “decision criterion heuristic,” and collectively as “decision criterion heuristics.” The programmable algorithm may be stored in a data processing system installed on the mobile wireless communications instrument or elsewhere. In addition, the mobile wireless communications instrument is operatively connected to a location determination system for obtaining geographic location data. In one aspect of the integrated alert system, a graphical mapping subsystem also may be operatively connected to the programmable algorithm and to the location determination system for providing visual presentations of the geographic location data displayed on the mobile wireless communications instrument.

Into the programmable algorithm a user may enter one or more scheduled events, one or more geographic locations, exit or entry into one or more geographic locations, and exit, entry, and/or traversal of a geographic boundary or area. On the occurrence of a scheduled event, in combination with the occurrence of imminent proximity to a geographic location, or actual entry into a geographic location, the programmable algorithm sends an alert notification in a variety of different methods of presentation to be sensed, heard, or seen by the user of a mobile wireless communications instrument.

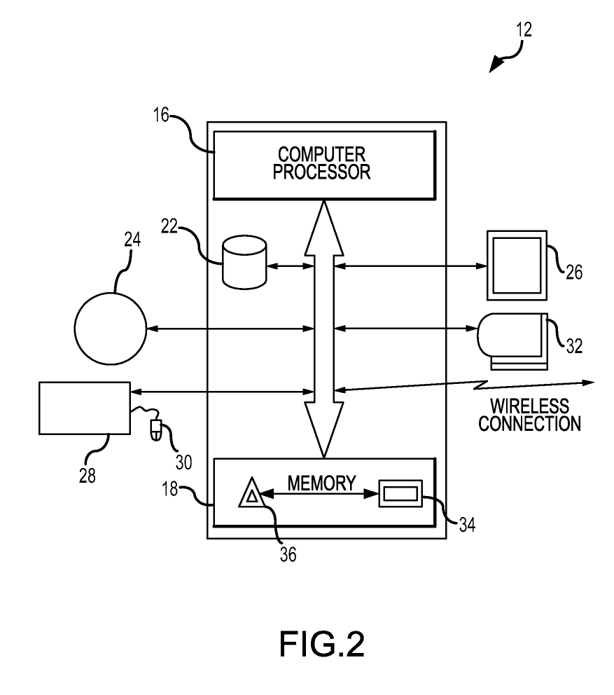

More specifically, as illustrated by cross-reference between FIGS. 1-7, the integrated alert system 10 includes at least one data processing system 12. As shown, the data processing system 12 is operatively connected to the mobile wireless communications instrument 14. In one aspect, the data processing system 12 is housed in the mobile wireless instrument 14. As illustrated by cross-reference between FIGS. 1-2, all data electronically embedded and stored in a memory and/or logic of the data processing system 12, including data personal to the user of the mobile wireless communications instrument 14, may be stored in the data processing system 12 for use as described in this document.

A general example of the data processing system 12 of the mobile wireless instrument 14 is illustrated in a non-exclusive example in the block diagram of FIG. 2. As shown, the data processing system 12 may include a variety of components to enable the mobile wireless instrument 14 to receive, process, store, and transmit data and information, including a data processor 16, memory 18, the data processor and memory connected by a bus 20. Memory is a relatively high-speed machine-readable medium and includes volatile memories such as DRAM, and SRAM, as well as non-volatile memories such as ROM, FLASH, EPROM, EEPROM, and bubble memory. Also connectable to the bus 20 are optional secondary storage 22, external storage 24, output devices such as a screen 38 that may be mounted on the mobile wireless instrument 14, and in optional configurations an input device such as a keyboard 28 with a mouse 30, and perhaps even a printer 32. Secondary storage 22 may include machine-readable media such as a hard disk drive, a magnetic drum, and a bubble memory.

External storage 24 may include machine-readable media such as a floppy disk, a removable hard drive, a magnetic tape, CD-ROM, and even other computers connected via a communications line. The distinction between secondary storage 22 and external storage 24 is primarily for convenience in describing the integrated alert system. As such, a person skilled in the art will appreciate that there is substantial functional overlap between and among the components. Computer software and user programs can be stored in a software storage medium such as memory 18, secondary storage 22, and external storage 24. Executable versions of computer software can be read from a storage medium such as non-volatile memory, loaded for execution directly into volatile memory, executed directly out of non-volatile memory, or stored on the secondary storage 22 prior to loading into volatile memory for execution.

In addition, those skilled in the art also will appreciate that the various illustrative logical blocks, modules, circuits, and algorithm steps described in connection with aspects of the invention disclosed in this document may be implemented as electronic hardware, computer software, or combination of both. To clearly illustrate this interchangeability of hardware and software, various illustrative and non-exclusive components, blocks, modules, circuits, and steps have been described in this document generally in terms of their functionality. Whether such functionality is implemented as hardware or software depends on the particular application and design constraints imposed on an overall system. Skilled artisans may implement the described functionality in varying ways for each particular application, but such implementation decisions should not be interpreted as causing a departure from the scope of the present invention.

The various illustrative logical blocks, modules, and circuits described in connection with the aspects disclosed in this document may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices such as, in a non-exclusive example, a combination of a DSP and a microprocessor, a plurality of microprocessors, one or more microprocessors in conjunction with a DSP core, or any other such configuration.

As also illustrated by cross reference between FIGS. 1-2, the integrated alert system 10 also includes at least one executable program 34. The executable program 34 is stored in the data processing system 12. The data processing system 12 is capable of responding to the executable program 34 by processing location data received across the location determination system and displaying location information on a screen 38 of the mobile wireless communications instrument 14. In addition, the executable program 34 stored in the data processing system 12 also is capable of processing data related to one or more events, and displaying information relating to scheduled events on the screen 38 of the mobile wireless communications instrument 14. In addition, the executable program 34 is capable of providing an alert notification not only in a visual format of presentation on the screen 38 of the mobile wireless communications instrument, but also in an aural and/or vibratory presentation. The executable program 34 is illustrated by cross-reference between FIGS. 1-2 diagrammatically only as an aid in understanding the operation of the integrated alert system 10.

As also illustrated by cross-reference between FIGS. 1-2, the integrated alert system 10 may include a graphical mapping subsystem. The graphical mapping subsystem 40 is capable of contributing to the integration of data and information pertaining to a schedule event and a geographic location. In addition, the information provided by the graphical mapping subsystem 40 may be displayed on the screen 38 of the mobile wireless communications instrument 14.

As indicated, the integrated alert system 10 is capable of integrating both scheduled events and geographic locations, and displaying that information on a monitor 32 of the mobile wireless communications instrument 14. The algorithm and protocol in the form of an executable program is programmable by a user of the mobile wireless communications instrument 14.

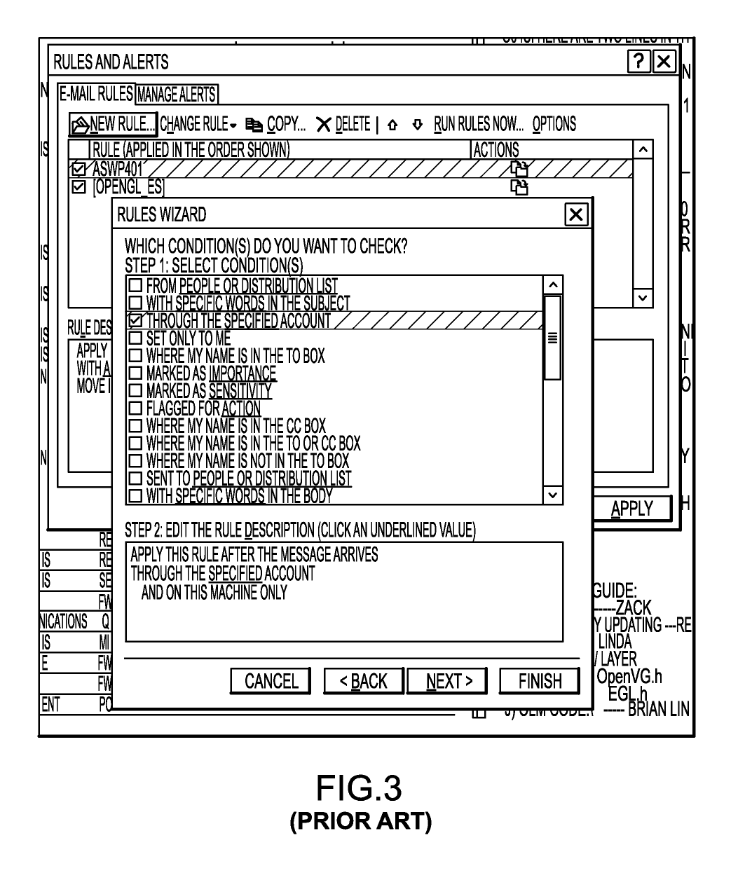

As illustrated by cross reference between FIGS. 3-5, systems currently are available for storing and recalling scheduled events. However, those systems are not capable of integrating scheduled events with location data and information as provided by the integrated alert system 10 of this document.

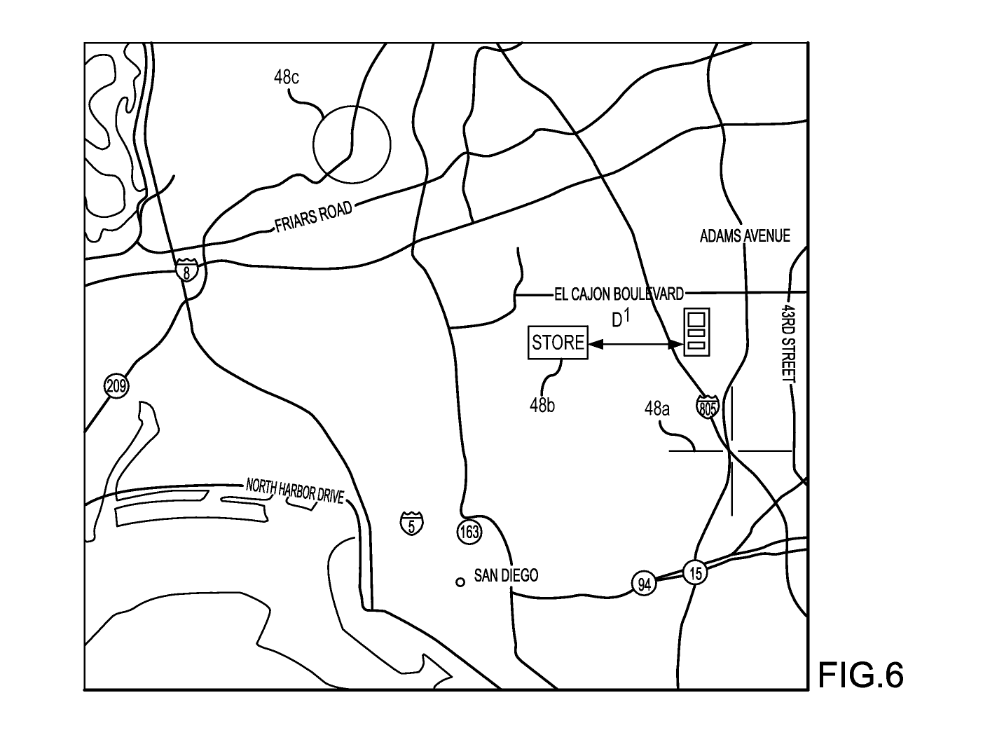

FIG. 6 illustrates one aspect of the operation of the integrated alert system 10. In operation a mobile wireless communications instrument is selected as illustrated by cross-reference between FIGS. 1-2. The mobile wireless communications instrument 14 is operatively connected to a programmable algorithm 36. The programmable algorithm 36 is stored in the mobile wireless communications instrument 14. In another aspect of the integrated alert system 10 the programmable algorithm 36 may be stored in one or more other locations, such as the network management center 42 illustrated in FIG. 1 which is operative within and across a mobile wireless communications system 44. More specifically, the programmable algorithm in the form of the executable program 34 is stored in a data processing system 12 located in the mobile wireless communications instrument 14. In addition, the mobile wireless communications instrument is operatively connected to a location determination system 46a,b. In one aspect of the integrated alert system 10, the graphical mapping subsystem 40 is provided. The graphical mapping subsystem 40 is operatively connectable to the programmable algorithm 36 as well as to the location determination system 46a,b. As a result, as illustrated in FIG. 6, one or more rules may be created to be executed by the executable program 34. As illustrated in FIG. 6, a location 48a-c may be identified by latitude and longitude from a data base of locations.

In another aspect, the distance D¹ between a mobile wireless communications instrument 14 and at least one geographical location 48b may be identified. Further, in another aspect of the integrated alert system 10, the screen 38 on the mobile wireless communications instrument 14 may provide one or more shapes 48-c defining a geographic location in terms of an area or region rather than based on specific geographic coordinates. An alert as described in this document may be sent to the mobile wireless communications instrument based on any of the foregoing geographic location determinants, as well as on the happening or occurrence of one or more events.

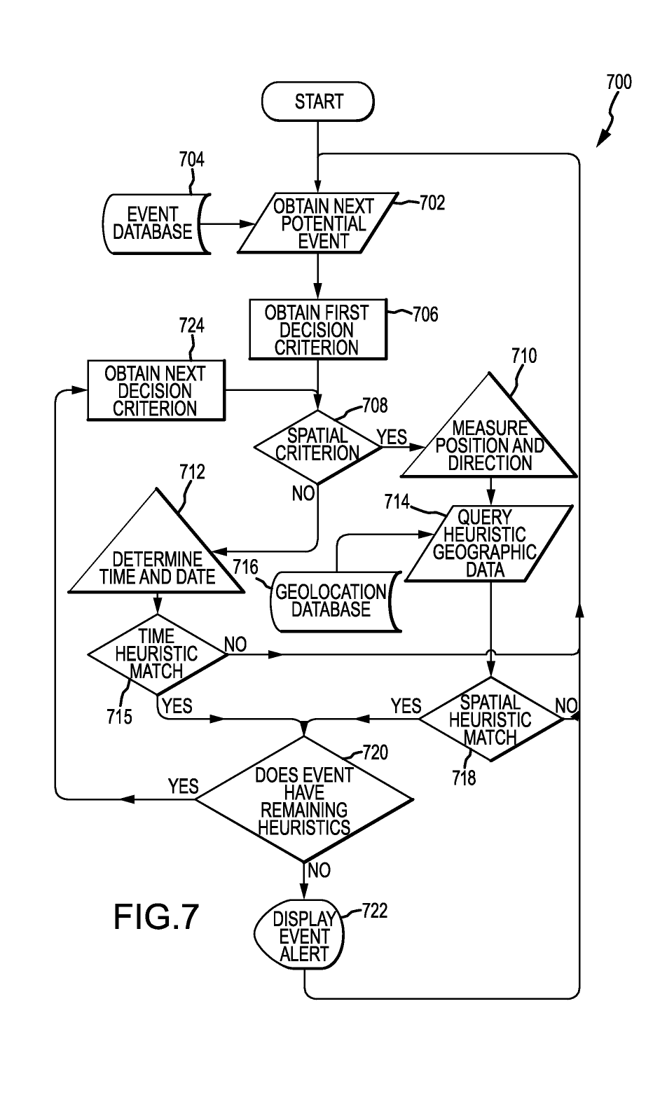

Referring now to FIG. 7, a flow chart 700 is provided to further explain the operation of the integrated alert system 10. At least two aspects of the method of automatically providing an alert notification using the integrated alert system 10 are shown in FIG. 7, and summarized by flow chart 700. As illustrated in flowchart 700, in a continuous loop executed on a schedule and augmented by a priority of events, any potentially valid events may be evaluated based on their heuristic criteria.

The steps of operation as shown in flowchart 700 are as follows. Each event identified at step 702 is obtained from the event database 704. At step 706 the first decision criterion heuristic is extracted from the collection of heuristics criteria that comprise a potential event. There may be one criterion or a plurality of criteria in any event to be compared and tested. The time criterion will be first unless there is a plurality of time criteria for comparing and testing in an event. The current criterion selected at step 706 is then tested to see if the criterion is a spatial criterion at step 708. If it is a spatial criterion, the algorithm proceeds to step 710; if not, the algorithm proceeds to step 712. At step 710 the geographic location of the mobile wireless communications instrument is obtained through measurement using the available system level functionality. In step 714 the prerequisite geospatial information is obtained from the geolocation database 716. This geolocation database may, for example, contain shape information, zip code boundaries, highway information or store and restaurant information. The database may be stored or cached on the mobile wireless communications instrument, or obtained remotely over a digital wireless data service and temporarily cached on the mobile wireless communications instrument. The scope of the database query is limited by the geolocation obtained in step 710 and the known bounds of the test heuristic. The data obtained in step 710 and step 714 are then used in the specified heuristic query in step 718. If the test criteria results in a match, the algorithm proceeds to step 720. If not, the algorithm aborts the event as having failed one of the criteria and returns to step 702 to begin processing the next event. At step 720, if there are additional criteria remaining, then the algorithm proceeds to step 724 where the next criterion is obtained before proceeding to step 708 and processing this new heuristic. However, if at step 720 this is the final criteria which has been met with success, then an alert is generated and displayed in step 722. Step 722 may include the generation of graphical, aural and haptic alerts.

If at step 708 the heuristic criterion was a time based event, then the algorithm proceeds to step 712 where current date and time information is measured from the system clock or location determination system. The date and time information is compared to the date and time criteria associated with the particular heuristic criterion at step 712. If the date and time criterion is not met, then testing for the event is abandoned and the algorithm returns to step 702, and processing for the next event begins. If, however, the date and time heuristic produces a positive match, execution proceeds to step 720. As before, if this is the final successful criterion, all criteria have been met for the event, and an alert is generated at step 722. The inclusion of a dynamic scheduling database is envisioned as analogous to the geospatial query of steps 714 and 716, although simple event scheduling information may be stored in the event heuristic in one or more embodiments.

The spatial query heuristic at step 716 may include speed and velocity (velocity being speed with direction), the concepts of proximity to a location, the proximity to a collection of locations such as banks, gas stations or restaurants or geographic boundaries or drawn shapes, shapes and exiting or entering a region is also encapsulated through the operation of steps 710, 714, 716 and 718. In one embodiment, at step 710 a system level function will occur to poll the algorithm. The history of motion can either be available through system functionality or through persistent storage of positional information by step 710 for iterative use including tracking history to generate speed and velocity for use by step 718.

The flowchart of FIG. 7 is an example of a list of criteria combined in each event with a logical AND operation to keep the description clear, but the invention is not limited by FIG. 7. Other logical combinations of events, including a logical OR operation, are possible through adjustments to the algorithm presented in FIG. 7.

A user also may form a link that alerts the user to buy groceries when the user is within, for example, a half mile of his favorite (and therefore pre-selected) grocery store 40a within a period of time on a specific day of the week. Likewise, a user could be alerted to purchase gasoline when passing a gasoline station offering lower than customary rates per gallon. In addition, alerts could occur either on entering a region 40c, leaving a region 40c, being within a certain distance of a region, or being outside a certain distance of a region 40c.

Claim elements and steps in this document have been numbered solely as an aid in understanding the description. The numbering is not intended to, and should not be considered as intending to, indicate the ordering of elements and steps in the claims. In addition, the integrated alert system illustrated drawing FIGS. 1 through 7 shows at least one aspect of the integrated alert system that is not intended to be exclusive, but merely illustrative of the disclosed embodiments. Method steps may be interchanged sequentially without departing from the scope of the integrated alert system. In addition, means-plus-function clauses in the claims are intended to cover the structures described as performing the recited function that includes not only structural equivalents, but also equivalent structures.

What is claimed is:

1. A method of automatically providing an alert notification, comprising:
selecting a mobile wireless communications instrument;
connecting the mobile wireless communications instrument operatively to a programmable algorithm stored in the mobile wireless communications instrument;
connecting the mobile wireless communications instrument operatively to a location determination system;
providing a graphical mapping subsystem operatively connectable to the programmable algorithm and to the location determination system;
entering either at least one scheduled event or at least one geographic location into the programmable algorithm; and
prompting an alert notification to a user of the mobile wireless communications instrument on integration of the at least one scheduled event or the at least one geographic location.

2. A method of automatically providing an alert notification as recited in claim 1, further comprising the step of installing a data processing system in the mobile wireless communications instrument capable of storing the at least one scheduled event and the at least one geographic location.

3. A method of automatically providing an alert notification as recited in claim 2, further comprising the substep of storing the programmable algorithm in the data processing system.

4. A method of automatically providing an alert notification as recited in claim 1, further comprising the step of providing at least one monitor mounted on the mobile wireless communications instrument for displaying geographic location information.

5. A method of automatically providing an alert notification as recited in claim 1, further comprising the step of providing at least one monitor mounted on the mobile wireless communications instrument for displaying information about a scheduled event.

6. A method of automatically providing an alert notification as recited in claim 4, wherein the step of prompting an alert notification to a user of the mobile wireless communications instrument on integration of the at least one scheduled event or the at least one geographic location includes the substeps of:
A) providing a visible alert notification to a user of the mobile wireless communications instrument; and/or
B) providing an aural alert notification to a user of the mobile wireless communications instrument; and/or
C) providing a vibratory alert notification to a user of the mobile wireless communications instrument.

7. A method of automatically providing an alert notification as recited in claim 1 wherein the step of connecting the mobile wireless communications instrument operatively to a location determination system includes the substep of connecting the mobile wireless communications instrument operatively to an SPS system and/or a terrestrial ground based positional tracking system.

8. A method of automatically providing an alert notification as recited in claim 1 wherein the step of identifying at least one geographic location includes the substeps of:
A) identifying latitude and longitude from database of locations if desired;
B) determining distance between mobile wireless communications instrument and at least one geographical location if desired; and
C) illustrating on the at least one monitor a shape defining a geographic location.

9. An alert system for integrating events and geographic locations, comprising:
a mobile wireless communications instrument operatively connectable to a location determination system;
a data processing system operatively connectable to the mobile wireless communications instrument and adapted to receive, store, process, and transmit events data and geographic location data;
at least one executable program stored in the data processing system capable of processing location data received across the location determination system; and
at least one executable program stored in the data processing system capable of processing data related to one or more events.

10. An alert system for integrating events and geographic locations as recited in claim 9, further comprising a graphical mapping subsystem adapted to display location information on the mobile wireless communications instrument.

11. An alert system for integrating events and geographic locations as recited in claim 10, further comprising a monitor adapted to display location information provided by the graphical mapping subsystem.

12. An alert system for integrating events and geographic locations as recited in claim 11, wherein the monitor is capable of displaying scheduled event information.

13. An alert system for integrating events and geographic locations as recited in claim 12, wherein the at least one executable program stored in the data processing system is capable of processing location data received across the location determination system.

14. An alert system for integrating events and geographic locations as recited in claim 13, wherein the at least one executable program stored in the data processing system is capable of processing data related to one or more events.

15. An alert system for integrating events and geographic locations as recited in claim 14, wherein the at least one executable program is programmable by a user of the mobile wireless communications instrument.

16. An alert system for integrating events and geographic locations as recited in claim 15, further comprising means for providing an alert notification of the integration of location data and data related to one or more events presented on the mobile wireless communications instrument.

17. An apparatus for providing an alert, comprising:
means for communicating across a mobile wireless communications system;
means operatively connectable to the means for communicating across a mobile wireless communications system for presenting location data on the means for communicating across a mobile wireless communications system;
means operatively connectable to the means for communicating across a mobile wireless communications system for presenting event data on the means for communicating across a mobile wireless communications system; and
means storable in the means for communicating across a mobile wireless communications system data for initiating the alert.

18. An apparatus for providing an alert as recited in claim 17, wherein the means for communicating across a mobile wireless communications system is selected from the group of means for communicating across a mobile wireless communications system consisting of cellular telephone, cell phone, pager, satellite telephone, two-way pager, personal digital assistant (“PDA”) having wireless capabilities, portable computer having wireless capabilities, and other type of wireless devices having transmission capabilities.

19. An apparatus for providing an alert as recited in claim 17, wherein the means for presenting location data includes a location determination system.

20. An apparatus for providing an alert as recited in claim 17, wherein the means for presenting location data includes a graphical mapping subsystem.

21. An apparatus for providing an alert as recited in claim 17, wherein the means for presenting location data includes a monitor mounted on the means for communicating across a mobile wireless communications system.

22. An apparatus for providing an alert as recited in claim 17, wherein the means for presenting location data includes a data processing system installed in the means for communicating across a mobile wireless communications system.

23. An apparatus for providing an alert as recited in claim 17, wherein the means for presenting location data includes a programmable algorithm storable in the means for communicating across a mobile wireless communications system.

24. An apparatus for providing an alert as recited in claim 17, wherein the means for presenting event data includes a monitor mounted on the means for communicating across a mobile wireless communications system.

25. An apparatus for providing an alert as recited in claim 17, wherein the means for presenting event data includes a data processing system installed in the means for communicating across a mobile wireless communications system.

26. An apparatus for providing an alert as recited in claim 17, wherein the means for presenting event data includes a programmable algorithm storable in the means for communicating across a mobile wireless communications system.

27. A storage medium containing computer software encoded in machine-readable format for providing an alert, the computer software comprising:
A) a set of computer instructions for substantially automatically linking a mobile wireless communications instrument to a location determination system;
B) a set of computer instructions for substantially automatically entering and tracking the location of the mobile wireless communications instrument;
C) a set of computer instructions for substantially automatically storing the location of one or more desired geographic locations in the mobile wireless communications instrument;
D) a set of computer instructions for substantially automatically comparing the location of the mobile wireless communications instrument with the location of the one or more desired geographic locations;
E) a set of computer instructions for substantially automatically storing one or more scheduled events in the mobile wireless communications instrument;
F) a set of computer instructions for substantially automatically alerting the user of the mobile wireless communications instrument about the proximity of the one or more desired geographical locations and the occurrence of the one or more events; and
G) a set of computer instructions for repeating the set of computer instructions A) through F).

28. A storage medium containing computer software encoded in machine-readable format for providing an alert as recited in claim 27, the computer software further comprising a set of computer instructions for identifying latitude and longitude from a database of locations.

29. A storage medium containing computer software encoded in machine-readable format for providing an alert as recited in claim 27, the computer software further comprising a set of computer instructions for displaying the one or more scheduled events.

30. A storage medium containing computer software encoded in machine-readable format for providing an alert as recited in claim 27, the computer software further comprising a set of computer instructions for displaying the one or more geographic locations.

31. A storage medium containing computer software encoded in machine-readable format for providing an alert as recited in claim 27, the computer software further comprising a set of computer instructions for determining distance between the mobile wireless communications instrument and the one or more geographic locations.

32. A storage medium containing computer software encoded in machine-readable format for providing an alert as recited in claim 27, the computer software further comprising a set of computer instructions for displaying on the mobile wireless communications instrument at least one monitor a shape defining a geographic location.

33. A storage medium containing computer software encoded in machine-readable format for providing an alert as recited in claim 27, the computer software further comprising a set of computer instructions for providing an alert notice on the occurrence of both proximity to the one or more geographic locations and the one or more scheduled events.

34. A method of using one or more data processing systems operatively connectable to a mobile wireless communications instrument to provide an alert, the method comprising the steps of:
A) installing in the data processing system at least one protocol for receiving, storing, processing, and displaying an event;
B) installing in the data processing system at least one protocol for receiving, storing, processing, and displaying a geographic location;
C) connecting the data processing system to a location determination system;
D) entering into the protocol one or more events to activate the alert;
E) entering into the protocol one or more geographic locations to activate the alert;
F) programming the at least one protocol to alert a user of a mobile wireless communications instrument of the imminent or actual occurrence of the one or more events and the one or more geographic locations substantially at the same time; and
G) repeating steps A) through F).

35. A method of using one or more data processing systems operatively connectable to a mobile wireless communications instrument to provide an alert as recited in claim 34, wherein the step of connecting the data processing system to the location determination system includes the substep of operatively connecting the data processing system to the mobile wireless communications instrument.

36. A method of using one or more data processing systems operatively connectable to a mobile wireless communications instrument to provide an alert as recited in claim 34, wherein the step of programming the at least one protocol to alert a user of a mobile wireless communications instrument of the imminent or actual occurrence of the one or more events and the one or more geographic locations substantially at the same time includes the substeps of:
A) alerting the user aurally;
B) alerting the user visually; and/or
C) alerting the user vibrationally.

37. A method of integrating scheduled events and geographical location data, comprising:
A) storing scheduled events in an event database;
B) selecting from at least one of the scheduled events one or more decision criterion heuristics;
C) testing the one or more decision criterion heuristics for compliance with one or more spatial criteria;
D) measuring position and direction data if the testing step is satisfied;
E) providing a database having geolocation data;
F) combining the position and direction data with the geolocation data to confirm a spatial heuristic match;
G) displaying the spatial heuristic match for visual viewing; and
H) repeating at least one of steps A) through G).

38. A method of integrating scheduled events and geographical location data as recited in claim 37, further comprising the step of determining the time and date if the testing step is not satisfied.

39. A method of integrating scheduled events and geographical location data as recited in claim 37, wherein the step of providing a database having geolocation data includes the substeps of:
I) providing shape information;
J) providing a zip code boundary or similar postal area location or zone;
K) transit route information; and/or
L) commercial locations by subject matter.

40. A method of integrating scheduled events and geographical location data as recited in claim 37, wherein the step of selecting from at least one of the scheduled events one or more decision criterion heuristics includes the substeps of including speed and velocity as a decision criterion heuristic.

41. A method of integrating scheduled events and geographical location data as recited in claim 37, wherein the step of testing the one or more decision criterion heuristics for compliance with one or more spatial criteria includes the substep of testing for altitude.
